(19) United States
(12) Patent Application Publication
(10) Pub. No.: US 2014/0339025 A1
(43) Pub. Date: Nov. 20, 2014

(54) GUIDE/DAMPER ARRANGEMENT FOR AN ELEVATOR

(71) Applicant: Inventio AG, Hergiswil (CH)

(72) Inventor: Hans Kocher, Udligenswil (CH)

(21) Appl. No.: 14/363,314

(22) PCT Filed: Nov. 29, 2012
(86) PCT No.: PCT/EP2012/073952

§ 371 Date: Jun. 6, 2014

(30) Foreign Application Priority Data
Dec. 19, 2011 (EP) 11194302.3

(51) Int. Cl. B66B 7/04

(52) U.S. Cl. CPC B66B 7/041
USPC 187/409

(57) ABSTRACT

A guide/damper arrangement for an elevator has a sliding guide shoe, which can be moved along on a guide rail and for guiding an elevator car, and a damper unit, for reducing vertical oscillations of the elevator car during standstill, and the two form a structural unit. The damper unit and the guide shoe are fastened on a common carrier, wherein the carrier is fastened on the elevator car. The damper unit is integrated in the guide shoe wherein a sliding surface, which is assigned to a guide surface of the guide rail and belongs to the sliding guide shoe, has arranged in it at least one damping region which is separate from the sliding surface, is configured as a braking surface and can be pressed against the guide rail with the aid of a control device in order to reduce the vertical oscillations of the car.

### FIELD

The invention relates to an arrangement for an elevator combining a guide shoe and a damper unit.

### BACKGROUND

Persons or goods entering or leaving the elevator car cause, due to the elasticity of the support means, undesired vertical oscillations of the car. Such vertical oscillations arise particularly in the case of elevators which are based on support belts as support means and which have enjoyed increasing popularity in more recent times. Since belts by comparison with steel cables have less favorable oscillation behavior the vertical oscillations increasingly impair the sense of comfort of passengers and the operational reliability. Moreover, the problem is amplified with increasing elevator height. In order to reduce vertical oscillations of that kind it is known to make use of separate damper units which—by comparison with, for example, safety brakes or other safety-relevant brake devices—act on the guide rail with a low braking force.

A damper unit for reducing vertical oscillations of the elevator car in standstill phases has become known from, for example, EP 1 424 302 A1. An elevator car with a damper unit, which acts on one of the two mutually opposite guide surfaces of the guide rail by a pressing force, is disclosed therein. In order to activate the damper unit during cage standstill this is mechanically coupled with a door opening unit of the car. On opening of the car door a brake element present at a free end of a lever arm is simultaneously pressed against the guide rail. However, due to the complicated lever and transmission mechanism this solution is expensive and susceptible to fault. A further disadvantage is that an unfavorable distribution of force to the car and to the guide rail arises due to the braking force introduced at one side.

### SUMMARY

It is accordingly an object of the present invention to avoid the disadvantages of the prior art and, in particular, to create an arrangement for an elevator by which the elevator car can be guided in improved mode and manner at the guide rails during car travel and by which vertical oscillations of the elevator car in standstill phases can be reduced in simple manner.

Numerous advantages result from the fact that the damper unit and the guide shoe form a constructional unit. Through the combination of the two components to form a compact constructional unit the arrangement has advantages in terms of production engineering and advantages for assembly of the elevator installation. Thus, the compact arrangement according to the invention can be connected with the car in a few working steps during final assembly in the elevator shaft.

The arrangement can in that case comprise a sliding guide shoe which is movable along a guide rail extending in a running direction. The guide rails have mutually opposite guide surfaces and an end-face guide surface connecting the two guide surfaces. Apart from sliding guidance, the arrangement also reduces in optimum manner undesired vertical oscillations, which are produced by changes in load, of the elevator car during standstill. Through the integration of the damper unit for reducing the vertical oscillations of the car in the sliding guide shoe separate damper units are no longer necessary. A further advantage results from the substantial saving of weight. Finally, it is possible in simple manner with the arrangement to retrofit existing installations at low cost.

The common constructional unit can be created in a first form of embodiment in that the damper unit and the guide shoe are fastened to a common support. The two components can be fastened at the support with use of fastening means known to the expert. The fastening means can be screw connections, rivet connections or mechanically positive connections. However, also conceivable are other forms of connection such as, for example, welding, soldering or gluing. The individual components can be fastened to the support by the same or different forms of connection.

The support can comprise a fastening arrangement, for example a threaded hole or a passage hole for receiving screws, by way of which the support is or can be fastened to the car and, in particular, to a car frame part of the car by means of fastening means in the form of, for example, screws. The support can, for example, be formed as a metal plate or include plate-shaped area sections, which are preferably connected with one another at right angles.

For an advantageous arrangement the damper unit can be integrated in a guide shoe, in which case for the integration at least one sub-region of one of the slide surfaces of the sliding guide shoe can be formed in such a manner that a pressing force can be exerted on the guide rail at least by way of the sliding surface sub-region. The mentioned sub-region thus forms a damping region which during car travel is slidingly loaded by a guide surface of the guide rail and during standstill phases is pressed against the guide surface for vibration damping. The sliding surface sub-region can in that case be formed in such a manner that during car travel it can be slidably guided along the respective guide surface to a rest position. This slide surface sub-region can thus, for example, have a region which in a rest setting forms a slide surface or is part of the slide surface. In that case, the slide surface sub-region can be deformable inwardly (or in the direction of the guide surface of the guide rail) for producing the pressing force for the oscillation damping. The slide surface is locally deformed in an activated position. The slide surface can lie, together with the damping region, in the rest position on a common plane, whilst in the active setting the slide surface can be curved in the damping region. However, in theory it would even be conceivable to transfer this active mechanism to a brake unit.

The slide surface can be formed by a slide lining, which is supported on a resilient support wall preferably consisting of spring steel. The support wall can be deformable inwardly in the form of a curve under the action of engagement means in the form of, for example, rams or eccentric bodies of eccentric discs, wherein the support wall after removal of the action of the engaging means automatically regains its original shape. The slide lining can, for example, be formed by an areal plastics material component. However, it can be advantageous if the slide lining is a component of a single-part or multi-part slide element which is approximately U-shaped in cross-section. Equally, the support wall could be a component of a support structure which is formed in cross-section as a U-shaped profile. The support structure can, together with the slide element, be inserted into the guide channel of the guide shoe housing. A form of embodiment without a support wall would also be conceivable. In this case, the engagement means would be in direct operative connection with the slide lining.

The engagement means for deforming the slide surface for generating the pressing force for the oscillation damping can preferably comprise disc-shaped eccentric bodies which predetermine a rest setting or an active setting depending on the respective rotational position.

Instead of a damping region predetermined by the slide surface the damping region can, in an alternative form of embodiment, be separate from the slide surface. Thus, at least one damping region can be arranged in a slide surface, which is associated with a guide surface of the guide rail, of the sliding guide shoe and can be pressed against the guide surface with the help of an activatable setting device. With a damper unit integrated in that way in the guide shoe a vibration damping which is sufficient for the comfort of passengers and for installation reliability can be achieved in standstill phases efficiently and with comparatively low pressing forces. The afore-mentioned sub-region or the damping region can be formed by, for example, a surface which is arranged to be set back relative to the adjacent slide surface and thus is not acted on by the guide surface during car travel. At car standstill and particularly when the car doors are opened the setting device can be activated and the damping region pressed or urged against the guide surface of the guide rail after a control command transmitted by an elevator control. Vertical oscillations can be simply and efficiently reduced to a sufficient extent or, if required, even entirely or almost entirely prevented by this braking action. Tests have shown that comparatively low pressing forces are needed for reduction of the vertical oscillations during car standstill.

However, in a further alternative it can also be advantageous if, apart from a slide surface of the sliding guide shoe, a damping region is provided which is separate from the slide surface and which for reduction of the vertical oscillations of the elevator car during standstill can be pressed against the guide surface of the guide rail with the help of a setting device activatable by means of, for example, an actuator unit. In that case it can be particularly advantageous if the damping region adjacent to the slide surface is arranged directly at or at a spacing from the slide surface of less than 300 millimeters, preferably less than 150 millimeters and particularly preferably less than 100 millimeters, from the edge.

A particularly compact construction can be created if the setting device of the damper unit is a component of the constructional unit through fastening to the common support.

Further advantages can be achieved if the arrangement comprises an actuator unit activatable by means of a control unit, wherein the actuator unit is fastened to the support. In that case, the actuator unit can preferably comprise an electric motor. The electric motor can, for example, be formed as a stepping motor, by which the desired pressing force for reduction of the vertical oscillations of the car is settable with a high degree of precision.

The sliding guide shoe can have at least one guide channel with mutually opposite slide surfaces. In that case, at least one of the opposite slide surfaces can have the damping region which is mentioned in the introduction and which is pressable against the guide surface. The guide channel can extend in running direction and embrace the guide rail.

It can also be advantageous if the arrangement for formation of the damping region has a cut-out or an interruption in the slide surface in which a brake surface is arranged. If, for example, the arrangement comprises a slide element for forming the slide surfaces it can be advantageous if the brake surface is formed by a separate component. In the case of the cut-out, the brake surface can be arranged in the slide surface in such a manner that the brake surface is surrounded by a slide surface or is arranged adjacent thereto.

For example, the arrangement can have on at least one side facing a guide surface of the guide rail a brake surface with which a respective slide surface section is connected on at least one and preferably both sides with respect to the running direction. The respective slide surface can thus consist of two slide surface sections which are interrupted by a brake surface or separated from one another by the brake surface.

It can be particularly advantageous if the brake surface in a rest setting is positioned to be set back relative to the slide surface preferably by at least a minimum distance or spacing. For optimum travel operation the brake surface in the rest setting is positioned to be set back relative to the slide surface by a spacing of at least 0.5 millimeters and preferably at least one 1 millimeter.

By comparison with the slide surface the brake surface can have a surface with a higher coefficient of friction. Moreover, it can be advantageous if the slide surface and the brake surface are based on different materials. A slide element forming the slide surface can consist of, for example, PTFE or UHMW-PE or of a different synthetic material with a low coefficient of friction.

The brake surface can be, for example, a metallic surface. Equally, the brake surface—like the adjacent slide surfaces—could obviously consist of a synthetic material. Good damping results can be achieved if the brake surface has a coefficient of friction which is at least twice, preferably at least three times and particularly preferably at least four times, as high as that of the slide surface.

Moreover, the arrangement can have a damping region with a brake surface, which can be actively pressed against the guide surface, on a side (with respect to the guide channel or the guide rail) of the sliding guide shoe. On the other or on the opposite side it can have a second damping region which, for example, is formed by a brake surface and which can be actively or passively pressed against the opposite guide surface.

An advantageous arrangement can have, on one side of the sliding guide shoe, a passive brake surface which is formed to be stationary with respect to the sliding guide shoe. The arrangement can additionally have on the other side of the sliding guide shoe an activatable brake surface which after activation is movable by way of the setting device entirely or partly in the direction of the respective guide surface of the guide rail.

The arrangement can comprise a brake element which has a brake surface and which is mounted in a guide housing to be displaceable transversely and preferably at a right angle to the direction of running. Moreover, a slide element which is U-shaped in cross-section can be inserted in the guide shoe housing. The slide element can be constructed as a one-part component forming a U-section.

At least one brake element of the arrangement can in that case be designed as a brake block activatable by means of the setting device. The brake block can have a substantially block-shaped form at least with respect to its plan outline. The arrangement can further comprise, on at least one side of a guide shoe housing facing a guide rail, a cavity which is complementary with the brake block and in which the brake block is received to be displaceable.

The brake block can have a bearing opening in the form of, for example, a bore in which an eccentric body eccentrically and rotatably mounted in the guide shoe housing or in which a control body rotatably mounted in the guide shoe housing is arranged. Eccentric body or control body can be connected with an electric motor, as actuator, either directly or by way of a transmission for imparting the rotational movement. The eccentric mechanism allows a precise and at the same time simple action on the brake surface by a pressing force with a high level of force transmission for reduction of the vertical oscillations of the elevator car in standstill phases, whereby small actuators (for example electric motors) can be used. However, obviously also other solutions for moving the brake block are conceivable in principle.

A holding jaw, which is preferably provided with a brake surface, as passive brake element can be arranged in the sliding guide shoe opposite the brake block. On activation of the opposite brake block the guide rail can be clamped in place between the brake block and the holding jaw. The holding jaw thus constitutes a form of opposing bearing against which the guide rail can be supported.

The holding jaw can preferably be fixedly connected with the support. Moreover, it can be particularly advantageous if the sliding guide shoe has a slide surface opposite to the brake block and if the brake surface of the holding jaw in a rest setting is positioned to be set back relative to the adjacent slide surface preferably by at least a minimum distance.

An alternative form of embodiment concerns an arrangement in which are provided two brake elements which each have a respective brake surface and which are movable simultaneously by a common setting device. The brake elements can in that case preferably be fixedly connected together and are pivotable about an axis of rotation (preferably arranged symmetrically with respect to the slide surfaces and/or brake surfaces) from a rest setting to an active setting for application of the pressing force for the oscillation damping. The two brake elements can be designed to be monolithic or of one-piece construction by way of fastening means.

The invention can be further directed to an elevator with a car guided along guide rails, wherein the car comprises at least one arrangement of the afore-described kind. It can be particularly advantageous if the car has at least one such arrangement and a conventional guide shoe. The car can thus comprise for each guide rail, for example, a guide shoe with a damping function for reducing the vertical oscillations of the car and a guide shoe without such a damping function.

### DESCRIPTION OF THE DRAWINGS

Further individual features and advantages of the invention are evident from the following description of embodiments and from the drawings, in which:

FIG. 1 shows a simplified illustration of an elevator in a side view,

FIG. 2 shows a substantially simplified illustration of an arrangement according to the invention for the elevator according to FIG. 1, in a plan view,

FIG. 3 shows a schematic illustration of a further arrangement in a rest setting,

FIG. 4 shows the arrangement in an active setting,

FIG. 5 shows a schematic part view of an arrangement according to an alternative embodiment,

FIG. 6 shows a constructional solution for the arrangement according to the invention (in rest setting) in a perspective illustration,

FIG. 7 shows the arrangement of FIG. 6 in active setting,

FIG. 8 shows a perspective illustration of an alternative arrangement,

FIG. 9 shows a perspective illustration of the arrangement according to FIG. 8 from a different viewing angle,

FIG. 10 shows a lever arrangement with two brake elements for the arrangement according to FIGS. 8 and 9,

FIG. 11 shows a rear view of the arrangement according to the embodiment of FIG. 8 in a perspective illustration of somewhat reduced scale,

FIG. 12 shows the arrangement of FIG. 11, but without bracket,

FIG. 13 shows a perspective illustration of the arrangement according to an alternative embodiment,

FIG. 14 shows a plan view of the arrangement according to FIG. 13,

FIG. 15 shows a front view of the arrangement in rest setting,

FIG. 16 shows the arrangement in active setting and

FIG. 17 shows a schematic illustration of a further variant of an arrangement (rest setting).

### DETAILED DESCRIPTION

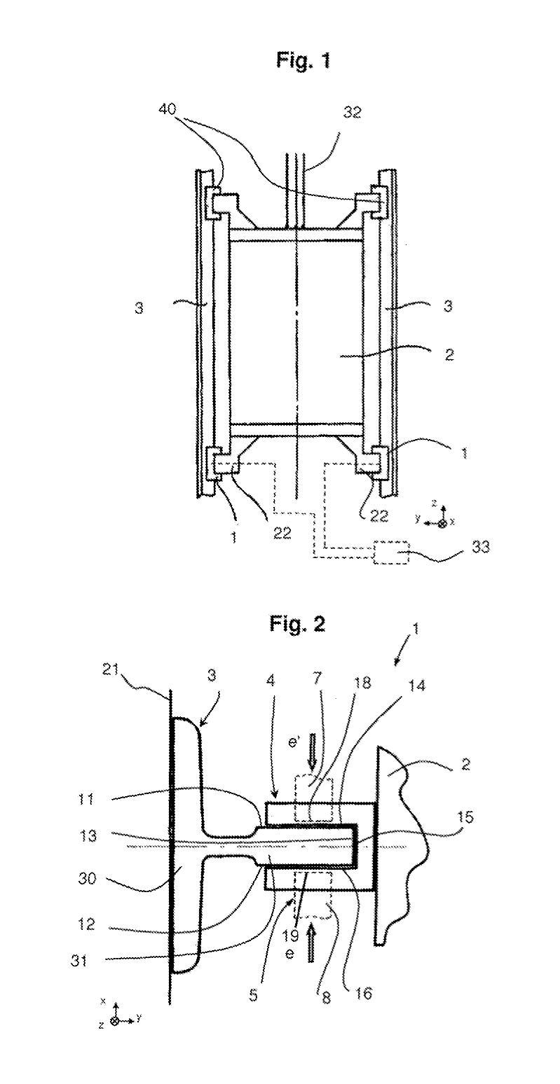

FIG. 1 shows an elevator with an upwardly and downwardly movable car 2 for transport of persons or goods. Serving as support means for movement of the car 2 are, for example, support means 32 in the form of belts or cables. The elevator installation has guide rails 3, which extend in vertical running direction z, for guidance of the car 2. The guide rails 3 have three planar guide surfaces extending in the z direction. Sliding guide modules 1 and 40, which during car travel slide with small play along the guide surfaces of the guide rails 3, are arranged at the car 2. The upper module 40 is a conventional sliding guide shoe. An arrangement is denoted by 1, which on the one hand serves for sliding guidance of the car along the guide rails. By contrast to the sliding guide shoe 40, which is known per se, the arrangement 1 is provided with an additional function. In concrete terms, undesired vertical oscillations of the car during standstill can, in addition, be reduced by the arrangement 1. Vertical oscillations of that kind arise when persons enter or leave the car 2. Due to the load change, the car 2 is set into oscillation. This phenomenon is particularly pronounced in the case of elevators based on support belts and elevators with high shaft heights. In order to reduce these vertical oscillations a damper unit (not illustrated here) activatable by way of a control device 33 is integrated in the guide/damper arrangement 1. The control device 33 transmits, for example as soon as the car stops or when the car door opens, a control command to the arrangement 1 for activation of the damper unit. The activation is usually maintained until the doors are closed again and appreciable load changes are thus no longer possible. The damper unit 5 and the guide shoe 4 are fastened to a common support 22 and thus form a particularly advantageous constructional unit. The support 22 is fastened to the car 2 (particularly to a car frame part of the car).

The basic construction and manner of operation of the guide/damper arrangement 1 according to the invention is evident from FIG. 2. As apparent from the substantially simplified illustration according to FIG. 2 the arrangement 1 includes a sliding guide shoe 4 for guidance of the car 2 along the guide rail 3. The sliding guide shoe 4 has, as is evident, a guide channel which embraces the guide rail. The guide rail 3 is formed as a T-section and comprises a rail foot 30, which is mounted on a shaft wall 21, and a rail web 31. The rail web 31 has two mutually opposite guide surfaces 11, 12 as well as an end-face guide surface 13. The sliding guide shoe 4 has a guide channel which is formed to be complementary with the guide web 31 and has slide surfaces 14, 15, 16. Brake elements 7, 8 of a damper unit 5 are arranged in the region of the mutually opposite slide surfaces 14, 16 of the guide channel of the sliding guide shoe 4 on both sides. The brake elements 7 and 8 have brake surfaces 18, 19 facing the guide surfaces 11, 12. The brake surfaces 18, 19 arranged in the slide surfaces 14, 16 form damping regions which for reduction of the vertical oscillations of the car 2 in standstill state phases can be pressed against the guide surfaces 14, 16 with the help of an activatable setting device (not illustrated here). As apparent from the rest position shown in FIG. 2, the brake surfaces 18, 19 in the rest position are positioned to be set back relative to the adjacent slide surfaces 14, 16. For oscillation damping the ram-like brake elements 7, 8 are moved against the guide rail 3 and pressed against this (the respective directions of movement are indicated by the arrows e and e′). The movement of the brake elements 7, 8 in that case preferably takes place simultaneously. The arrangement 1 with the sliding guide shoe 4 and with the damper unit 5 for reduction of vertical oscillations, which are produced during standstill by changes in load, of the elevator car forms, as apparent, a constructional unit. A compact arrangement 1 of that kind is particularly superior with respect to costs, need for space and weight by comparison with previously known systems.

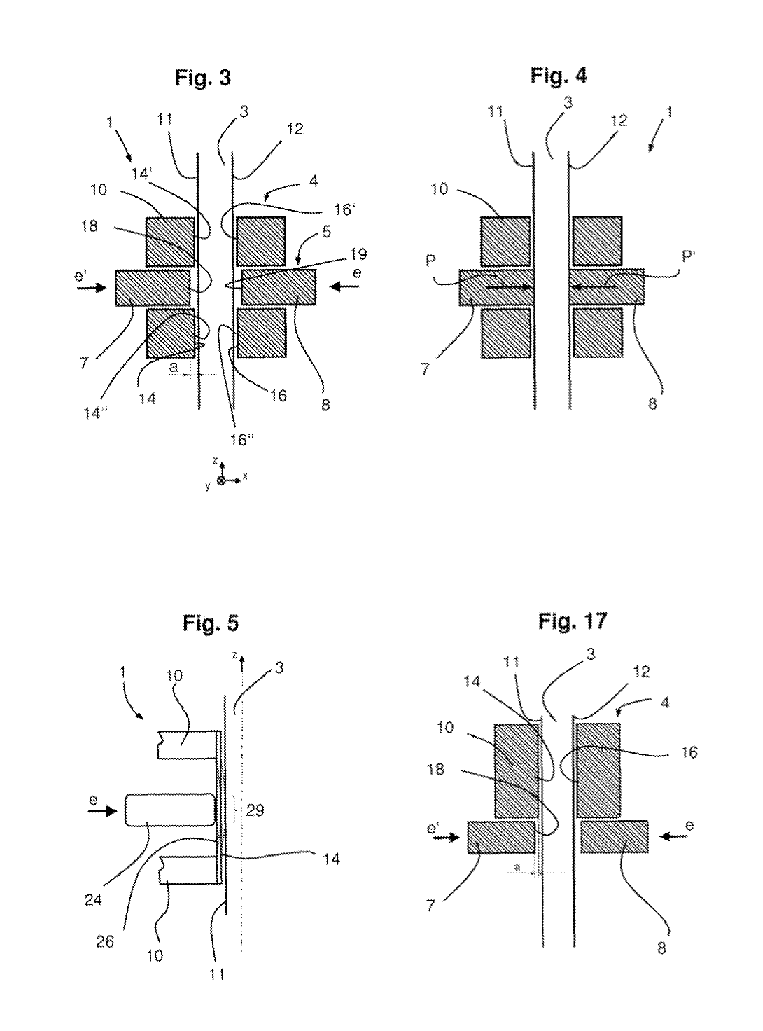

The principle of functioning of the arrangement for guidance of the elevator car and for reduction of the vertical oscillations in standstill phases is additionally shown by way of FIGS. 3 and 4. FIG. 3 shows an arrangement in which the two brake elements 7, 8 are in a rest position in which they do not act on the guide rail 3. The respective brake elements 7 and 8 are mounted in the guide shoe housing 10 to be displaceable approximately at a right angle to the running direction z and can be displaced in the x direction. The slide surface, in which the brake surface 18 is arranged approximately centrally, is of segment-like construction. The left-hand slide surface 14 associated with the guide surface 11 of the guide rail 3 accordingly consists of a first slide surface section 14′ and a second slide surface section 14″. The slide surface 16 associated with the guide surface 12 consists of identically formed slide surface sections 16′ and 16″. The spacing by which the brake surfaces 18 are offset outwardly or rearwardly relative to the slide surfaces in the rest setting is denoted by a. The spacing a is approximately 1 millimeter. A minimum spacing a of at least 0.5 millimeters is advantageous.

In FIG. 4 the brake elements 7, 8 are in an activated setting in which the brake elements 7, 8 are pressed against the guide rail 3. The respective pressing forces are indicated by the arrows P and P′. By virtue of the pressing action the vertical oscillations can be substantially reduced without use of higher levels of pressing force. Pressing forces of merely 500 to 1,000 N are needed for sufficient oscillation damping.

In the embodiment according to FIGS. 3 and 4 use is made of merely one brake element per side. However, for specific applications it would also be conceivable to provide two or more separate braking elements, which are arranged adjacent to one another with respect to the running direction z, per side, in which case the brake surfaces of the brake elements are arranged to be adjacent to one another or could be separated from one another by slide surfaces. The brake surfaces 18, 19 consist of a material different from the adjacent slide surfaces 14′, 14″ or 16′, 16″. The brake surfaces 18, 19 can be integrated components of the brake elements 7, 8 and monolithically connected therewith and therefore consist of the same material as the brake elements 7, 8. The brake surface 18, 19 has, by way of example, a coefficient of friction μ of between 0.2 and 0.3. By contrast, the slide surfaces 14 and 16 have a coefficient of friction μ of between 0.05 and 0.1.

FIG. 5 shows a further variant of the arrangement 1 according to the invention, wherein, however, in FIG. 5 merely a half of the arrangement is illustrated. The arrangement has per side a one-part slide surface 14 formed by a thin, areal component 26. The component 26, which is termed support wall in the following, is fastened at the edge side to a guide shoe housing 10. Arranged in a cavity in the guide shoe housing 10 is a ram 24 which is displaceable in the e direction and which in the case of movement in the e direction urges the support wall 26 away in inward direction approximately centrally. The thus-arched support wall 26 is indicated by the dot-dashed line. The region, which is acted on by the ram 24, of the support wall thus represents a specific damping region (slide surface sub-region) for reduction of vertical oscillations of the elevator car during standstill, which region is denoted by 29.

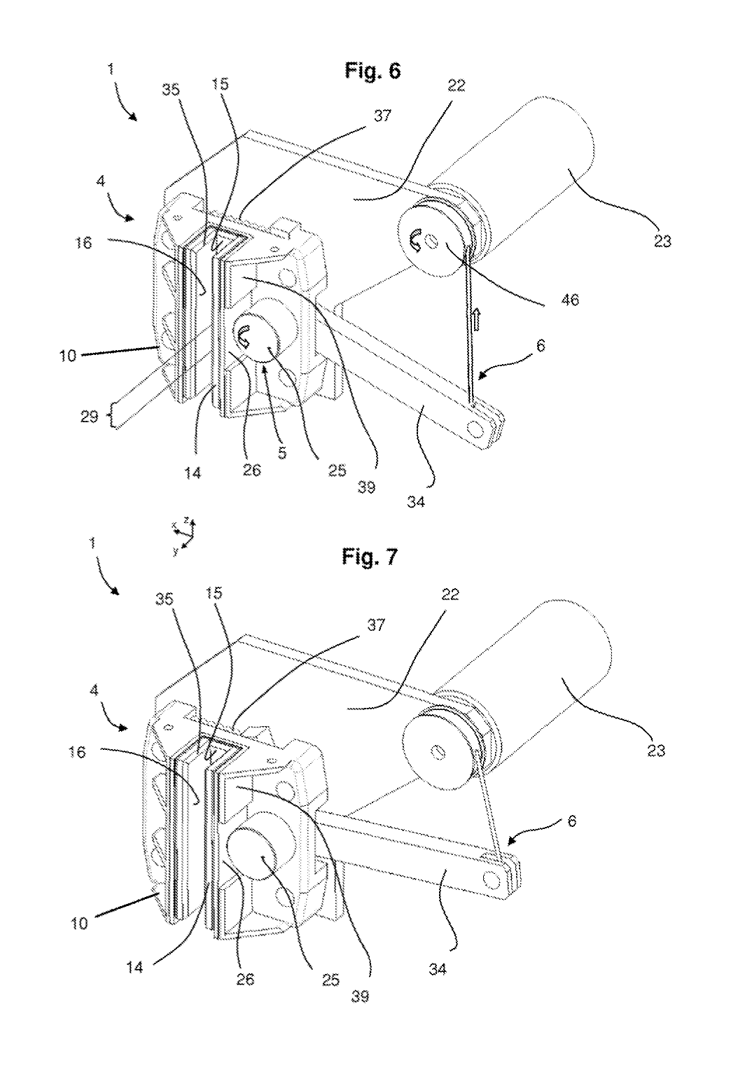

FIGS. 6 and 7 show a sliding guide shoe 4 with integrated damper unit 5. The arrangement comprises a guide shoe housing 10 with a receiving channel which extends in running direction and in which a slide element 35, which is U-shaped in cross-section, is inserted in the interior. The slide element 35 in that case forms the slide surfaces 14, 15 and 16 associated with the guide surfaces of the guide rail (not illustrated here). The slide surface which is denoted by 15 and associated with the end-face guide surface serves—by comparison with the mutually opposite regions with the planoparallel slide surfaces 14 and 16—exclusively for sliding guidance. The support 22 to which the guide shoe 4 together with the damper unit 5 is fastened is formed as a steel plate.

The side wall of the slide element 35 is supported by the slide surface 14 on a support wall 26 of spring steel. The support wall 26 is in turn laterally supported on channel side wall 39, wherein the channel side wall 39 is interrupted so that the support wall is exposed to the outside. In this region the eccentric disc 25 can act on the support wall 26, whereby the support wall is deformable inwardly under the action of the eccentric disc. The side (on the left in FIG. 7), which is deformed inwardly in the active setting together with the support wall 26, of the slide element 35 presses against the guide rail and thus produces a sufficient reduction of the disturbing vertical oscillations of the car. The resilient support wall 26 after removal of the action automatically regains its original shape.

The slide element 35 consists of, for example, PTFE or UHMW-PE material. The slide element 35 in the present case is preferably formed as a one-piece and monolithic component. Also conceivable, however, would be a multi-part construction. Thus, in the alternative three slide elements could be inserted into the sliding guide shoe, wherein each slide element would form a respective slide surface.

The slide element 35 is supported on the side, which is associated with the slide surface 16, over the entire side surface by the guide shoe housing 10. On the opposite side the side wall forming the receiving channel is interrupted so that a central wall section of the support element 26 is exposed. Disposed externally at the side wall 39 is an eccentric disc 25 which is mounted in the guide shoe housing 10 to be eccentrically rotatable by way of a setting device 6 from a rest setting to an active setting. The setting device includes a lever arm 34 which is connected with the eccentric disc 25 and which can be moved by way of a motor-driven cable pull. The motor 23 for driving the setting device 6 is—like the guide shoe 4—fastened to the support or bracket 22. In FIG. 6 the eccentric disc 25 is in a rest setting in which the cylindrical circumferential surface of the eccentric disc 25 does not act on the support wall 26 or contacts it merely in pressure-free manner. The drive unit 23 in the present case is in the form of an electric motor, wherein for precise activation of the damper unit use is made of step motors; particularly advantageous are, for example, direct-current motors or alternating-current motors. After activation of the electric motor 23 the lever arm 34 is pivoted into the setting shown in FIG. 7. Due to the eccentricity, the rotated eccentric disc 25 urges the support wall 26 away inwardly. Through this action of the eccentric disc a slight curvature of the support wall 26 and the associated side wall of the slide element 35 is thus caused.

The motor-driven actuator includes, by way of example, a cable drum 46 by which the eccentric is rotatable via a lever arm in a pivot movement. The electric motor 23 thus builds up a pressing force and the setting device 6 coupled with the motor acts against a pneumatic spring 37 supported in the guide shoe housing 10. The pneumatic spring 37 thus produces a restoring force, whereby after deactivation of the electric motor 23 the eccentric disc 25 automatically adopts the rest setting again. However, it would obviously also be conceivable in the alternative to use an electric motor activatable in two rotational directions. The electric motor could obviously also be arranged coaxially with respect to the eccentric axis of the eccentric disc 25, in which case the motor axis could be connected directly or by way of, for example, a step-down transmission with the eccentric disc. Alternatively, the electric motor could move the eccentric body 25 indirectly by way of, for example, a toggle-joint lever in order to thereby achieve a non-linear translation.

In the embodiment according to FIGS. 6 and 7 only one of the two planoparallel slide surfaces for generating a pressing force against the guide rail is designed to be active. The opposite slide surface 16 acts in passive mode and manner, in which the guide rail is clamped between the two slide surfaces 16 and 14. However, in theory it would also be conceivable to design both sides to be identical.

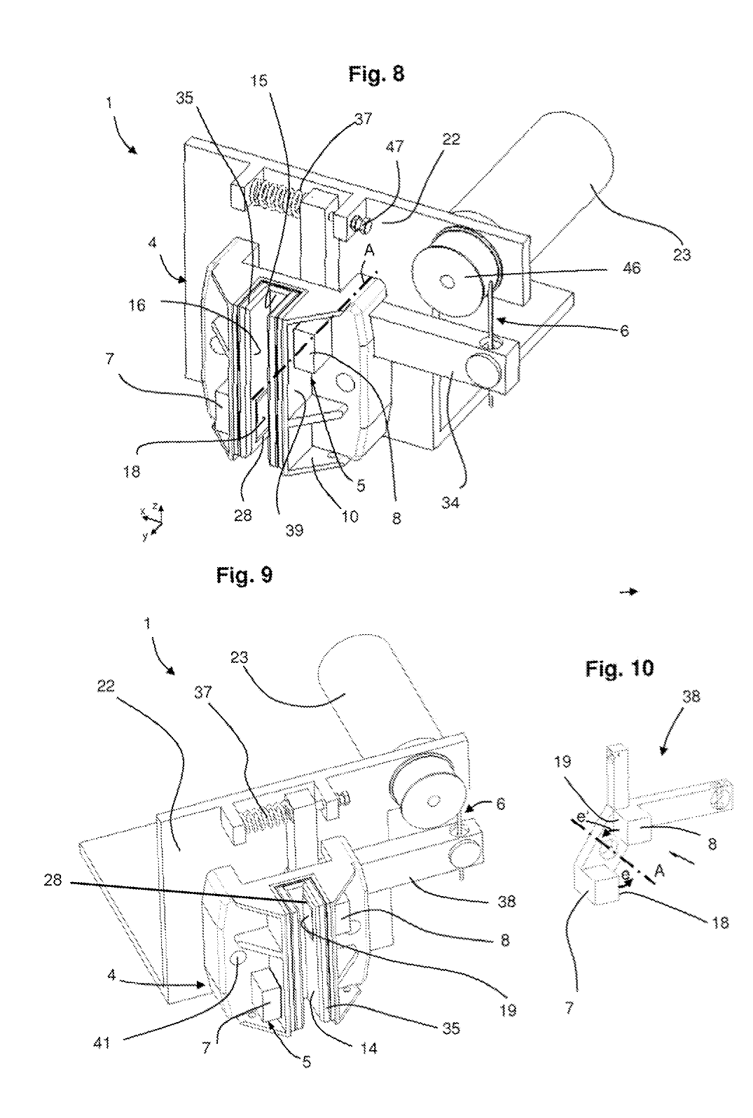

By contrast to the preceding embodiment, in which the damping region for reduction of the vertical oscillations of the car is formed by the slide surfaces themselves, in the embodiment according to FIGS. 8 and 9 the damping regions are predetermined by separate elements provided with brake surfaces. As evident from FIGS. 8 and 9, the mutually opposite slide surfaces 14 and 16 each have a respective recess 28, in which recesses the brake surfaces 18, 19 are arranged and respectively form the damping regions. The brake surfaces 18 and 19 can be reciprocatingly moved in the x direction by way of a setting device 6. Disposed on both sides of the sliding guide shoe 4 are thus damping regions with brake surfaces 18, 19 actively pressable against the guide surface of the guide rail. The guide shoe housing 10 is fixedly connected with the support 22.

The brake elements 7, 8 provided with the brake surfaces 18, 19 are pivotable about the axis A with the help of a lever arrangement 38. The rotation of the lever arrangement 38 about the axis A of rotation (FIG. 8) has the effect that a force couple acting on the guide rail is built up with opposite effective direction. The axis A, which extends horizontally in installed state, lies symmetrically between the slide surfaces 14 and 16. As evident from FIGS. 8 and 9, the brake surfaces 18 and 19 in the active setting protrude slightly inwardly relative to the adjacent slide surfaces 14 and 16 and thus produce pressing of the guide rail for reducing the undesired vertical oscillations of the elevator car. The rectangular brake surfaces have a higher coefficient of friction by comparison with the slide surfaces. Obviously also other setting devices and actuators could be provided for moving the brake elements 7 and 8. The brake surfaces 18 and 19 are arranged to be offset relative to one another with respect to the running direction z.

Thanks to the pneumatic spring 37 the lever arrangement 38 is so movable that in the rest setting a minimum air play with respect to the guide surfaces of the guide rail is present. The air play can be set by means of a pneumatic-spring screw 47. Alternatively, it would also be conceivable for the spring 37 to build up the pressing force and the actuator 23 to ventilate the damper unit.

The rotational movement of the electric motor 23 is, in the present embodiment, converted with use of a cable drum 46 into a linear movement and takes place without self-locking. However, obviously also alternative setting devices are conceivable. Coming into question are, for example, spindles, eccentrics or connecting rods with a crank wheel.

It is evident from FIG. 10 that the lever arrangement 38 is designed as a one-part monolithic component of metal at which the brake element 7, 8 is formed. The pivot axis A is centrally arranged between the two brake elements 7 and 8.

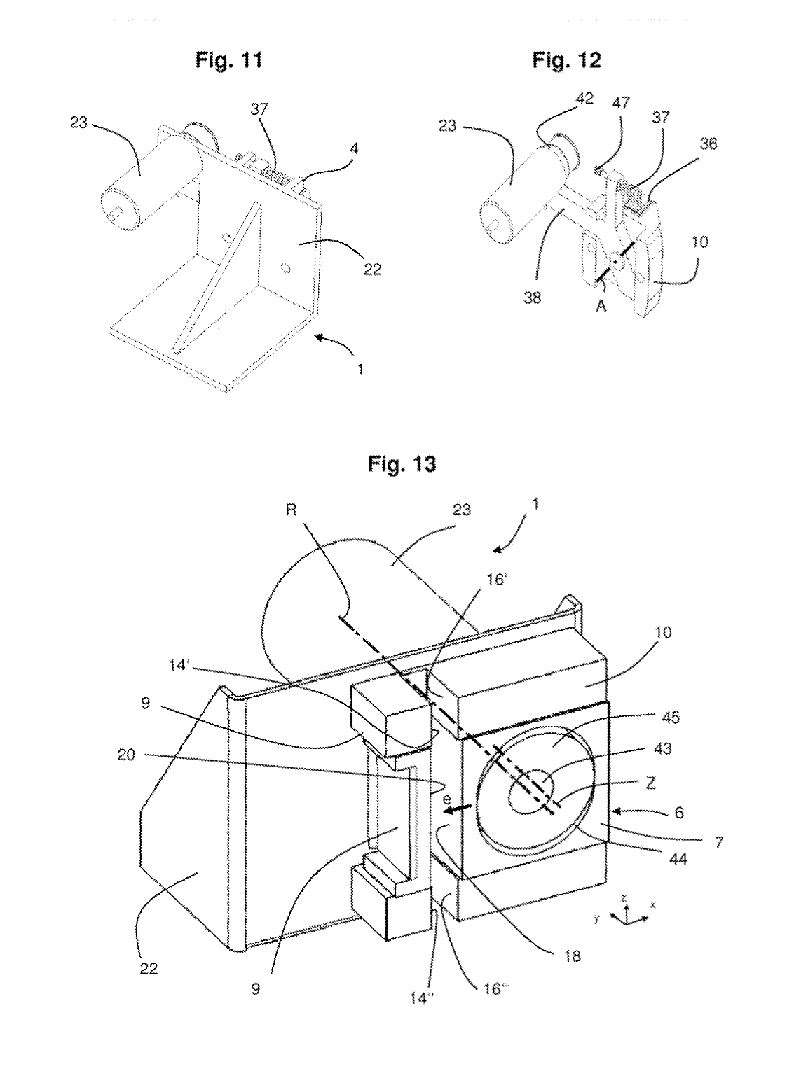

It can be seen from the perspective illustration according to FIG. 11 that the support 22 for holding the sliding guide shoe 4 and the damper unit, which is driven by the electric motor 23, for reduction of vertical oscillations is designed as an integral bracket with plate-shaped area sections adjoining one another at right angles, wherein the area sections are connected together at the rear side by a support structure to be stiff in bending. The support 22 is fastened to a car by way of fastening means such as, for example, screws via a fastening arrangement (not illustrated here).

FIG. 12 shows a rear view of the arrangement without bracket. This illustration clarifies, in particular, the rotatable mounting of the lever arrangement about the axis A in the guide shoe housing 10. Moreover, two passage holes 41 can be seen in FIG. 9, into which screws for fastening the guide shoe housing to the bracket are introducible. A fastening section of the drive unit is denoted by 42, which is receivable in a complementary recess in the bracket. The actuator unit, which is designed as an electric motor 23, is, as evident, fastened to the support 22.

FIG. 13 relates to a further embodiment for an arrangement according to the invention. The arrangement 1 has on one side a brake element 7 which is mounted in the guide shoe housing 10 in a cavity to be displaceable in the x direction. The brake element 7 has a brake surface 18 in the region of an inner side facing the guide rail. The guide channel is interrupted in the region of each of the mutually opposite guide surfaces. The brake surface 18 is received in the interruption, which is created by the cavity for reception of the brake element 7, and thus lies between two slide surface sections 16′ and 16″. For displacement of the approximately block-shaped brake element 7 use is made of a setting device 6 based on an eccentric mechanism. The setting device comprises an eccentric body 45 which is fixed on a drive stub axle 43 of the motor 23 to be secure against relative rotation. Here, too, the actuator unit, which is designed as an electric motor 23, is fastened to the support 22. The disc-shaped eccentric body 45 is received eccentrically in a bearing opening 44 to be mounted to be rotatable. The eccentric body 45 co-operates with the bearing opening 44 in such a manner that on rotation of the eccentric disc 45 the brake block can be reciprocatingly moved in the x direction. In order to produce the active setting the brake element 7 has to be displaced in the direction of the arrow e from the rest setting shown in FIG. 13. The axis of rotation of the motor is denoted by R. The central axis for the eccentric body 45 is denoted by Z. The axes R and Z, which are axially parallel, in the installed state (i.e. when the arrangement is mounted on the car and embraces the guide rail) extend in horizontal direction indicated by the arrow y of the Cartesian co-ordinate system illustrated here.

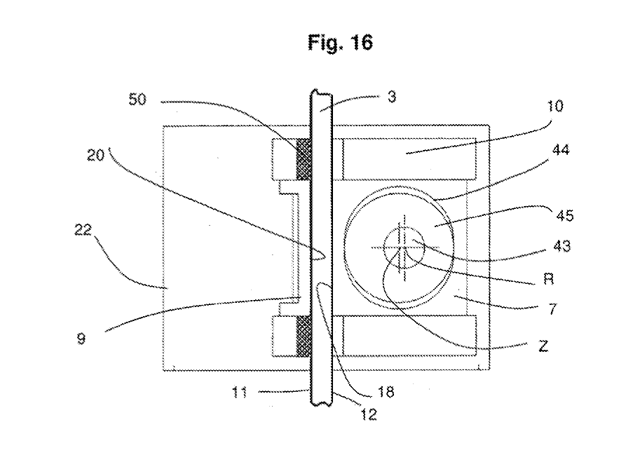

The brake element 7 is, in the present case, formed as a monolithic brake block. Since the brake block is preferably made from metallic materials (for example steel), the brake surface 18 accordingly has a metallic surface. However, in order to increase braking efficiency it would also be conceivable to coat the brake block in the region of the side 18 with a brake lining or to mount such. Good damping results can be achieved if the brake surface 18 has a coefficient of friction which is at least twice as high as that of the slide surface 16. By comparison with the brake block 7, a holding jaw 9 provided with a brake surface 20 is arranged as a passive brake element. The arrangement 1 thus has on one side a damping region with a brake surface 18 actively pressable against a guide surface of a guide rail. On the other side it has a second damping region which is formed by the brake surface 20 and which in active setting is passively pressed against the guide rail. The holding jaw 9 as a passive brake element thus forms a kind of counter-bearing at which the guide rail can be supported when the damper unit 5 is activated. From the rest setting shown in FIG. 13, there is no loading of the guide surfaces of the guide rail (not illustrated here) by the brake surfaces 18 and 20. In the simplified illustration of the arrangement according to FIG. 13 the respective slide surfaces 14′, 14″ as well as 16′ and 16″ are predetermined by the guide shoe housing 10. Obviously, use could also be made at the top and bottom of single-part or multi-part separate inlays, wherein the inner inlay part would respectively form the slide surfaces (cf. FIGS. 15 and 16 in the following).

The brake surface 18 of the brake element 7 is, in the rest setting shown in FIG. 13, positioned to be set back relative to the adjacent slide surface. This slide surface is composed of the slide surface sections 16′ and 16″ laterally adjoining the brake surface 18. The same applies in reverse sense. Here, too, the brake surface 20 is positioned to be set back relative to the slide surface 14. The holding jaw 9 is fixedly connected with the support 22. The holding jaw 9 and thus also the brake surface 20 are thereby to be arranged comparatively rigidly in the arrangement, whereas the adjacent slide surface sections 14′ and 14″ of the slide surface 14 can yield and thus enable braking frictional contact between brake surface 20 and the associated guide surface of the guide rail. This can be achieved—as evident from FIGS. 15 and 16—by additional elements 50 which can be pressed together when the active setting is provided.

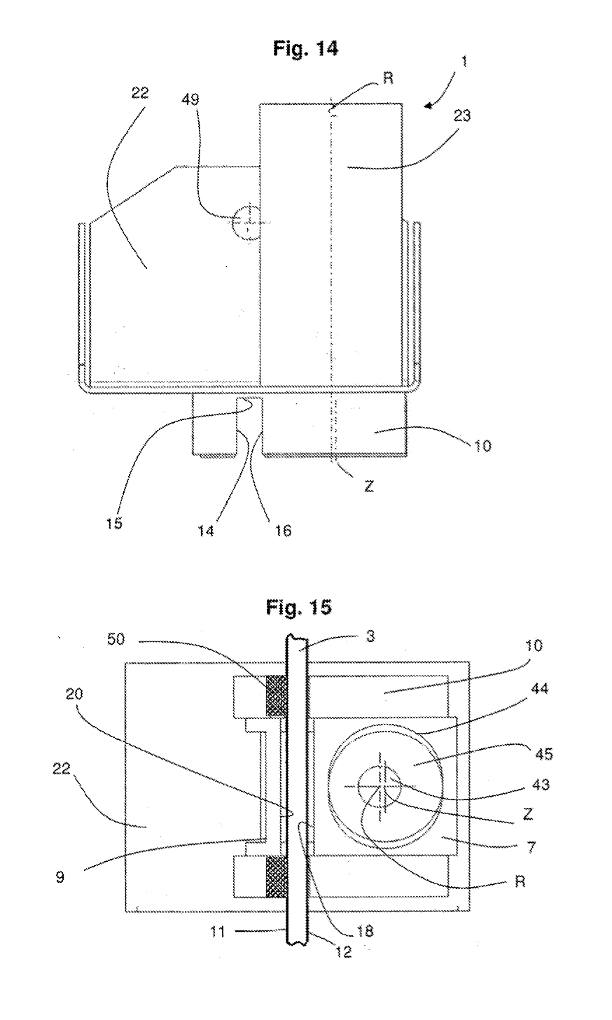

A view of the arrangement 1 in the z viewing direction is shown in FIG. 14. The electric motor 23 with its drive axis R can be recognized therefrom. The axis R of rotation and the Z axis extending parallelly at an eccentric spacing from R extend, as is apparent, perpendicularly to the end-face guide surface 15. The support 22 substantially consists of three planar area sections which mutually adjoin at right angles. A bore denoted by 49 is provided on an area section of the support 22 for fastening the arrangement 1 to the elevator car (particularly to a frame of the elevator car). A fastening screw received in the bore 49, but not illustrated here, forms an axis of rotation for a kind of floating mounting of the arrangement 1 in the elevator. Tests have shown that thanks to the fastening arrangement by way of the bore 49 a reliably functioning arrangement is created.

FIGS. 15 and 16 show the arrangement in the two operating positions. In the rest setting according to FIG. 15 the brake surfaces 18 and 20 are set back relative to the adjacent slide surfaces and thus each form an air gap. In the region of the side associated with the holding jaw 9 the slide surfaces for the guide surface 11 are predetermined by elements of a resilient material (preferably plastics material). The motor is activated for producing the active setting. The stub axle 43, which is preferably connected with the motor by way of a transmission, thereupon experiences a 180° rotation about the R axis, whereby the brake element is displaced against the guide surface 12. The brake element displaced in such a way is shown in FIG. 6. In order to permit the displacing movement the brake element 7 has a non-circular bearing opening 44 co-operating with the cylindrical circumference of the eccentric body. Approximately at the same time the resilient elements 50 are compressed on the opposite side and the brake surface 20 is pressed against the guide surface 11. With a design of that kind it is possible to optimally reduce vertical oscillations of the car during standstill to the desired degree. Instead of an eccentric mechanism the displacing movement for pressing the brake surfaces against the guide surfaces could also be achieved in another way. Thus, for example, the brake element 7 could also be moved by means of a linear drive, a lever mechanism or even with use of hydraulic or pneumatic means.

In the embodiment according to FIGS. 3 and 4 the respective brake surfaces lie between two sliding surface sections and thus in each instance overall in a slide surface. In the embodiment according to FIG. 5 the damping region similarly lies in the slide surface, wherein here the damping region is a component of the slide surface, for which purpose accordingly also use was made of the designation slide surface sub-region. However, as evident from FIG. 17, the damping region for reduction of the vertical oscillations of the elevator car during a standstill does not necessarily have to be arranged in the slide surfaces.

In accordance with the provisions of the patent statutes, the present invention has been described in what is considered to represent its preferred embodiment. However, it should be noted that the invention can be practiced otherwise than as specifically illustrated and described without departing from its spirit or scope.

1-11. (canceled)

12. A guide/damper arrangement for an elevator with a sliding guide shoe that is movable along a guide rail for guiding an elevator car and with a damper unit for reducing vertical oscillations of the elevator car during standstill, comprising: the damper unit being integrated in the guide shoe to form a constructional unit.

13. The arrangement according to claim 12 wherein the damper unit and the guide shoe are fastened to a common support.

14. The arrangement according to claim 13 wherein the support includes at least one passage hole for fastening to the car or a car frame of the car with a fastening means.

15. The arrangement according to claim 12 wherein the damper unit is integrated in the guide shoe by at least a damping sub-region of a slide surface of the guide shoe being formed to apply a pressing force to the guide rail.

16. The arrangement according to claim 12 wherein the damper unit is integrated in the guide shoe by at least one brake surface being arranged in a slide surface of the guide shoe, the slide surface being associated with a guide surface of the guide rail, the at least one brake surface being separate from the slide surface and being pressable by a setting device against the guide surface.

17. The arrangement according to claim 12 wherein separate from a slide surface of the guide shoe a brake surface is provided and for reduction of the vertical oscillations of the elevator car during standstill the brake surface is pressed against a guide surface of the guide rail by a setting device activatable by an actuator unit.

18. The arrangement according to claim 17 wherein a damping region is arranged adjacent to the slide surface at one of directly at the slide surface, at a spacing therefrom of less than 300 millimeters, at a spacing therefrom of less than 150 millimeters, and at a spacing therefrom of less than 100 millimeters.

19. The arrangement according to claim 17 wherein the setting device is a component of the constructional unit and is fastened to a common support with the damper unit and the guide shoe.

20. The arrangement according to claim 12 including an actuator unit, which is activatable by a control unit, for activating the damper unit wherein the actuator unit is fastened to a common support with the damper unit and the guide shoe.

21. The arrangement according to claim 12 including an actuator unit for activating the damper unit by an electric motor.

22. An elevator including at least one guide/damper arrangement according to claim 12 attached to the elevator car.
